(19) United States
(12) Patent Application Publication
(10) Pub. No.: US 2026/0131765 A1
(43) Pub. Date: May 14, 2026

(54) PROTECTIVE SHIELD FOR COVERING A HUBCAP WHEN CLEANING A TIRE

(71) Applicant: Tim Donaldson, Edgewater (CA)

(72) Inventor: Tim Donaldson, Edgewater (CA)

(21) Appl. No.: 18/941,652

(22) Filed: Nov. 8, 2024

(51) Int. Cl. B60S 3/04; B60B 7/00; B60B 7/04

(52) U.S. Cl. CPC B60S 3/042; B60B 7/0073; B60B 7/04

(57) ABSTRACT

A protective shield for covering a hubcap when cleaning a tire includes a central pin, arms coupled to the central pin, and a plurality of panels. Each of the arms extends radially from the central pin. The arms are selectively pivotable about the central pin between an expanded position in which the arms are fanned out and a collapsed position in which the arms are in a stack. Each panel is coupled to a respective arm. The panels form a circular shape to cover a hubcap of a vehicle when the arms are in the expanded position. A first arm and a second arm are positioned at the respective top and bottom of the stack of the arms, and are couplable together by first and second coupler members to hold the arms in the expanded position. A handle is attached to a respective one of the arms.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to tire cleaning devices and more particularly pertains to a new protective shield for covering a hubcap when cleaning a tire. When cleaning tires, cleaning liquids, sprays, and foams are used that can accidentally be deposited or run onto the hubcaps, thereby creating undesirable streaks and smears on the hubcaps. The protective shield is a handheld device that allows a user to cover the hubcap while the user cleans the surrounding tire.

### (2) Description of Related Art Including Information Disclosed Under 37 CFR 1.97 and 1.98.

The prior art relates to tire cleaning devices, including different types of covers for protecting the hubcaps. The prior art, as best understood, does not disclose a protective shield that has arms radially extending from a central pin, which protective shield is movable into a collapsed position in which the arms are in a stack one on top of another.

### (h) BRIEF SUMMARY OF THE INVENTION

An embodiment of the disclosure meets the needs presented above in a protective shield generally comprising a central pin, a plurality of arms coupled to the central pin, and a plurality of panels. Each of the arms extends radially from the central pin. Each of the arms is selectively pivotable about the central pin between an expanded position in which the arms are fanned out about the central pin and a collapsed position in which the arms are in a stack one on top of another. Each of the panels is coupled to a respective one of the arms. The panels are designed to together form a circular shape to cover a hubcap of a vehicle when the arms are in the expanded position. A first coupler member is positioned on a first arm of the plurality of arms and a second coupler member is positioned on a second arm of the plurality of arms. The first coupler member is selectively couplable with the second coupler member, wherein the first arm is positioned at the top of the stack of the arms and the second arm is positioned at the bottom of the stack of the arms when the arms are in the collapsed position. A handle is attached to a respective one of the arms. The handle is positioned to project from its respective arm. The handle is designed to be held by a user when cleaning a tire.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a protective shield according to an embodiment of the disclosure.

FIG. 2 is a perspective view of an embodiment of the disclosure in a collapsed position.

FIG. 3 is a side view of an embodiment of the disclosure.

FIG. 4 is a cross-sectional view of a portion of an embodiment of the disclosure shown in FIG. 3.

FIG. 5 is a side view of an embodiment of the disclosure in use.

FIG. 6 is a perspective view of an alternative embodiment of the disclosure.

### (j) DETAILED DESCRIPTION OF THE INVENTION

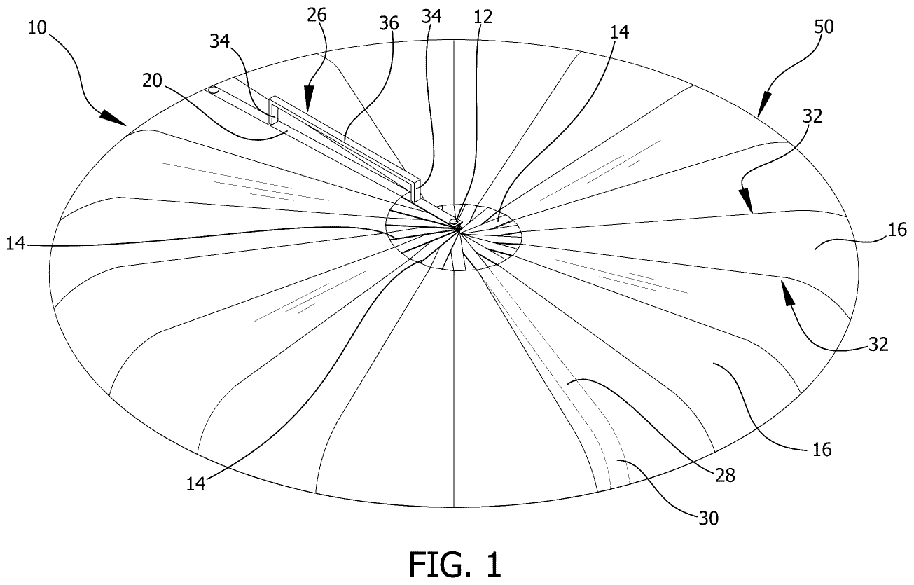

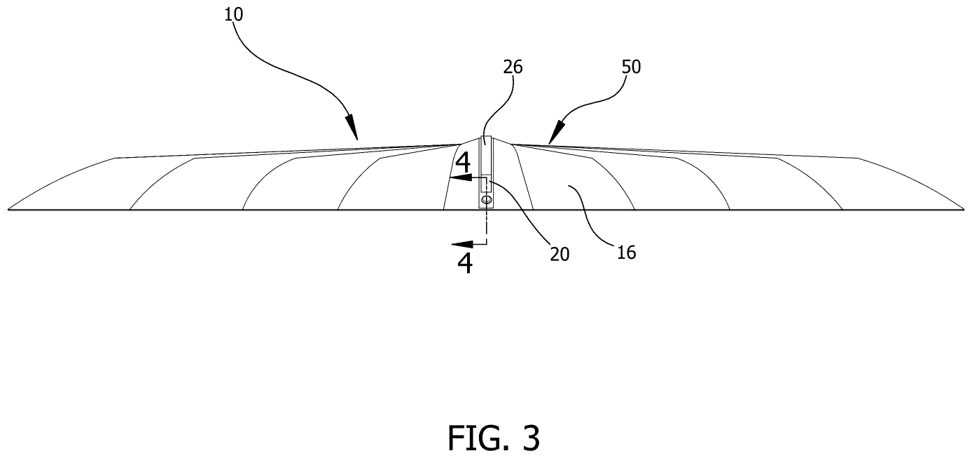

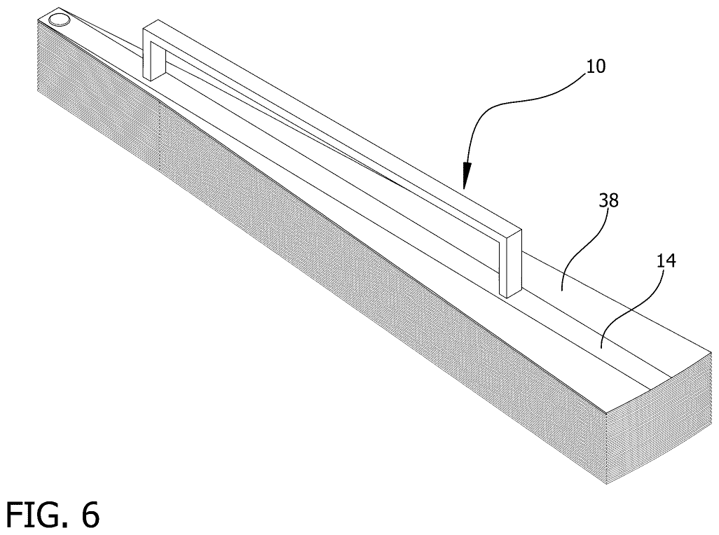

With reference now to the drawings, and in particular to FIGS. 1 through 6 thereof, a new protective shield embodying the principles and concepts of an embodiment of the disclosure and generally designated by the reference numeral 10 will be described.

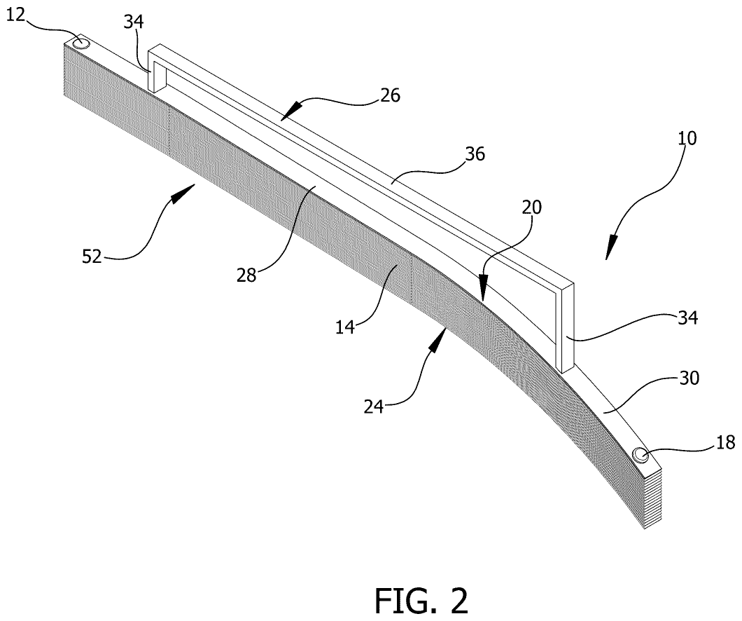

As best illustrated in FIGS. 1 through 6, the protective shield 10 generally comprises a central pin 12, a plurality of arms 14 coupled to the central pin 12, and a plurality of panels 16. Each of the arms 14 extends radially from the central pin 12. Each of the arms 14 is selectively pivotable about the central pin 12 between an expanded position 50 in which the arms 14 are fanned out about the central pin 12, as shown in FIG. 1, and a collapsed position 52 in which the arms 14 are in a stack one on top of another, as shown in FIG. 2. Each of the panels 16 is coupled to a respective one of the arms 14. The panels 16 are designed to together form a circular shape to cover a hubcap of a vehicle when the arms 14 are in the expanded position 50. A first coupler member 18 is positioned on a first arm 20 of the plurality of arms 14 and a second coupler member 22 is positioned on a second arm 24 of the plurality of arms 14. The first coupler member 18 is selectively couplable with the second coupler member 22, wherein the first arm 20 is positioned at the top of the stack of the arms 14 and the second arm 24 is positioned at the bottom of the stack of the arms 14 when the arms 14 are in the collapsed position 52. A handle 26 is attached to a respective one of the arms 14. The handle 26 is positioned to project from its respective arm. The handle 26 is designed to be held by a user when cleaning a tire 60.

Each of the arms 14 includes a shaft portion 28 coupled to the central pin 12 and an end portion 30 projecting downwardly from the shaft portion 28. The end portion 30 of each of the arms 14 is designed to be in contact with the tire 60 to support its respective shaft portion 28 a distance from the hubcap during cleaning of the tire 60. In the exemplary embodiment shown in FIGS. 1 and 2, the end portion 30 is curved. However, in one possible embodiment, the end portion 30 could be straight and at an angle to the shaft portion 28, or could be partly curved and partly straight.

Each of the panels 16 is made of a flexible material designed to be folded up when the arms 14 are in the collapsed position 52. For clarity, the flexible material is not shown in FIG. 2, though the flexible material would generally be gathered or folded up between the arms 14. In one possible embodiment, the arms 14 are inserted into the panels 16, which have either a double layer of the flexible material or have a sheath attached to the panel. The arms 14 could also be joined or bonded to the panels 16. Each of the panels 16 includes lateral sides 32 extending along a respective one of the arms 14. Each of the panels 16 is attached to one another at the lateral sides 32, such as by stitching or adhesive. In other possible embodiment, the panels 16 are integrally joined in a circular or ring-shaped piece. In the exemplary embodiment, the flexible material is water-resistant, such as by being made of water-resistant cloths or fabrics, or having a water-resistant coating, or by being made of plastic.

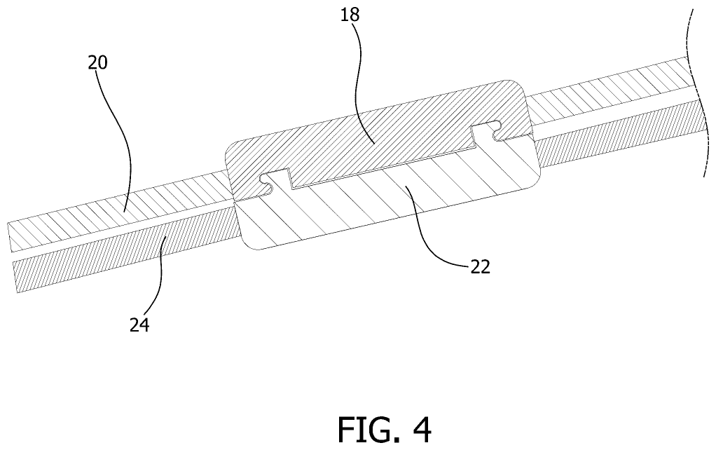

As shown in FIG. 4, the first coupler member 18 and the second coupler member 22 connect together in an interlocking manner. While a form fit is shown, the connection can be accomplished by snap fit structures, such as clasps or buttons, or possibly magnets. The first coupler member 18 is positioned at the end portion 30 of the first arm 20, and the second coupler member 22 is positioned at the end portion 30 of the second arm 24.

As seen in FIG. 1, the handle 26 is attached to the first arm 20. The handle 26 is in the shape of a bracket and includes: a pair of posts 34 projecting perpendicularly from the first arm 20, and a crosspiece 36 connecting the posts 34 and extending along the first arm 20.

In an alternative embodiment, instead of flexible material, each of the panels 16 is a wedge-shaped blade 38 projecting laterally from its respective one of the arms 14. Such blades 38 could be made of relatively stiff plastic. The arms 14 are straight in this embodiment, though could be formed with a curved or angled portion. The function of the panels 16 though is the same.

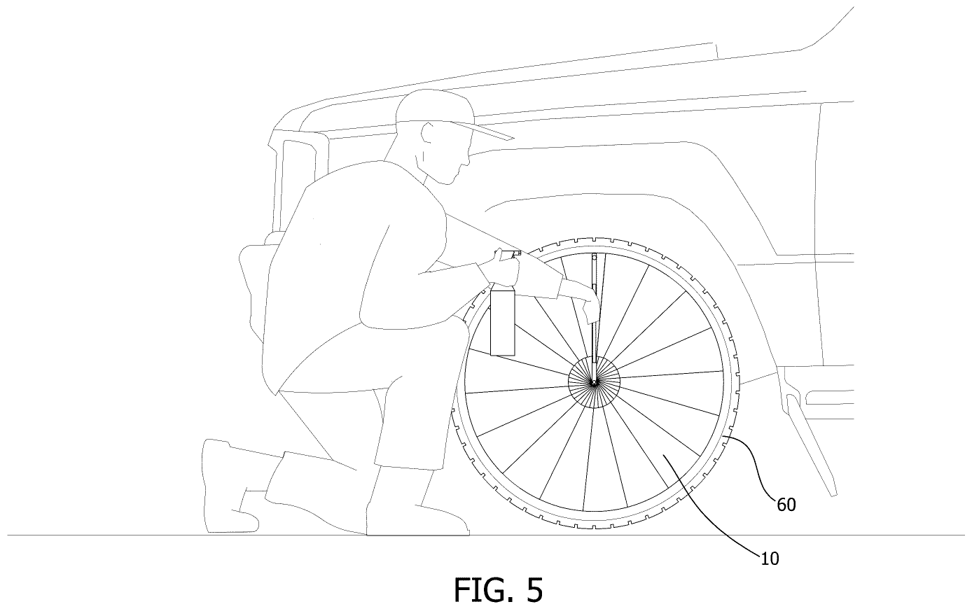

As shown in FIG. 5, the user fans out the arms 14 into the expanded position 50 and then holds the protective shield 10 over the hubcap, with the outer edge of the protective shield 10 braced against the tire 60. The user holds the protective shield 10 in one hand and cleans the tire 60 with the other hand. The protective shield 10 prevents any tire 60 cleaning material from getting onto the hubcap. When done using the protective shield 10, the user conveniently folds the protective shield 10 into the collapsed position 52, which can be stored compactly.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A protective shield for covering a hubcap when cleaning a tire comprising:
a central pin;
a plurality of arms coupled to said central pin, each of said arms extending radially from said central pin, each of said arms being selectively pivotable about said central pin between an expanded position in which said arms are fanned out about said central pin and a collapsed position in which said arms are in a stack one on top of another;
a plurality of panels, each of said panels being coupled to a respective one of said arms, said panels being configured to together form a circular shape configured to cover a hubcap of a vehicle when said arms are in said expanded position;
a first coupler member being disposed on a first arm of said plurality of arms and a second coupler member being disposed on a second arm of said plurality of arms, said first coupler member being selectively couplable with said second coupler member, wherein said first arm is disposed at the top of said stack of said arms and said second arm is disposed at the bottom of said stack of said arms when said arms are in said collapsed position; and
a handle, said handle being attached to a respective one of said arms, said handle being disposed to project from its respective arm, said handle being configured to be held by a user when cleaning a tire.

2. The protective shield of claim 1, wherein:
each of said arms includes a shaft portion coupled to said central pin and an end portion projecting downwardly from said shaft portion; and
said end portion of each of said arms is configured to be in contact with the tire to support its respective shaft portion a distance from the hubcap during cleaning of the tire.

3. The protective shield of claim 2, wherein said end portion is curved.

4. The protective shield of claim 1, wherein:
each of said panels is made of a flexible material configured to be folded up when said arms are in said collapsed position;
each of said panels includes lateral sides extending along a respective one of said arms; and
each of said panels is attached to one another at said lateral sides.

5. The protective shield of claim 4, wherein said flexible material is water-resistant.

6. The protective shield of claim 1, wherein each of said panels is a wedge-shaped blade projecting laterally from its respective one of said arms.

7. The protective shield of claim 1, wherein said first coupler member and said second coupler member connect together in an interlocking manner.

8. The protective shield of claim 1, wherein said first coupler member is disposed at said end portion of said first arm, and said second coupler member is disposed at said end portion of said second arm.

9. The protective shield of claim 1, wherein:
said handle is attached to said first arm; and
said handle is in the shape of a bracket and includes:
a pair of posts projecting perpendicularly from said first arm; and a crosspiece connecting said posts and extending along said first arm.

10. The protective shield of claim 3, wherein:
each of said panels is made of a flexible material configured to be folded up when said arms are in said collapsed position;
each of said panels includes lateral sides extending along a respective one of said arms; and
each of said panels is attached to one another at said lateral sides.

11. The protective shield of claim 10, wherein said flexible material is water-resistant.

12. The protective shield of claim 11, wherein said first coupler member and said second coupler member connect together in an interlocking manner.

13. The protective shield of claim 12, wherein said first coupler member is disposed at said end portion of said first arm, and said second coupler member is disposed at said end portion of said second arm.

14. The protective shield of claim 13, wherein:
said handle is attached to said first arm; and
said handle is in the shape of a bracket and includes:
a pair of posts projecting perpendicularly from said first arm; and
a crosspiece connecting said posts and extending along said first arm.

15. The protective shield of claim 3, wherein each of said panels is a wedge-shaped blade projecting laterally from its respective one of said arms.

16. The protective shield of claim 15, wherein said first coupler member and said second coupler member connect together in an interlocking manner.

17. The protective shield of claim 16, wherein said first coupler member is disposed at said end portion of said first arm, and said second coupler member is disposed at said end portion of said second arm.

18. The protective shield of claim 17, wherein:
said handle is attached to said first arm; and
said handle is in the shape of a bracket and includes:
a pair of posts projecting perpendicularly from said first arm; and
a crosspiece connecting said posts and extending along said first arm.
